(19) United States
(12) Patent Application Publication
(10) Pub. No.: US 2013/0301692 A1
(43) Pub. Date: Nov. 14, 2013

(54) METHOD FOR RANGING WITHOUT DOCSIS CHIPSET

(71) Applicant: Ben MAXSON, Beech Grove, IN (US)

(72) Inventor: Ben MAXSON, Beech Grove, IN (US)

(21) Appl. No.: 13/886,042

(22) Filed: May 2, 2013

Related U.S. Application Data
(60) Provisional application No. 61/641,616, filed on May 2, 2012.

(51) Int. Cl. H04L 1/24

(52) U.S. Cl. CPC H04L 1/244
USPC 375/222

(57) ABSTRACT

A method and test instrument for performing a ranging measurement in a DOCSIS network, uses low cost and general purpose electronics instead of a DOCSIS chipset. A downstream CATV receiver, including a CATV tuner and QAM demodulator, accepts the downstream signals from a CMTS. The output of the demodulator is an MPEG transport stream containing DOCSIS signaling messages and data packets. Software algorithms running inside a suitable general purpose processor decode the MPEG transport stream to isolate signaling messages from the data packets. The signaling messages are used to determine the appropriate format and timing of ranging request messages for the CMTS. A burst generator generates the RF return path messages to be sent to the CMTS, using previously computed waveforms.

### CROSS-REFERENCE TO RELATED APPLICATIONS

The present invention claims priority from U.S. Provisional Patent Application No. 61/641,616 filed May 2, 2012, the entirety of which is incorporated herein by reference.

### TECHNICAL FIELD

The present invention relates generally to communication testing, and more particularly to a method and test instrument for ranging in a DOCSIS network without a DOCSIS chipset.

### BACKGROUND OF THE INVENTION

Data Over Cable Service Interface Specification (DOCSIS) is an international telecommunications standard developed by CableLabs, which allows high-speed data transfer over an existing cable TV (CATV) system.

A DOCSIS system typically includes a cable modem (CM) located at the subscribers premises and a cable modem termination system (CMTS) located at the CATV headend. More specifically, one or more CMTSs, which access a backbone network (such as the Internet), are located in a headend system that is generally is stored within a central office of a cable service provider, while a plurality of CMs are located at different subscriber premises. The transparent, bi-directional, transfer of Internet Protocol (IP) traffic between the CMTSs and the CMs is achieved via a cable network. The communication direction from the CMTS to the CMs is referred to as the downstream direction, whereas the communication direction from the CMs to the CMTS is referred to as the upstream direction.

Traditionally, cable networks were based on coaxial cable that was laid up to and installed inside the subscriber's premises. However, with the growth of the Internet and desire to provide high-speed Internet access and/or on-demand programming, it is now common for sections of the coaxial cable to be upgraded to lower loss fiber. Accordingly, these cable networks are often referred to as Hybrid Fiber Coaxial (HFC) networks. In a typical HFC system, data carried by optical signals is transmitted over long distances of optical fibers, and then transformed to radiofrequency (RF) signals and transmitted over CATV cable. For example, in many HFC systems optical signals from the headend are transmitted on trunklines that go to several distribution hubs, from which multiple optical fibers fan out to carry the optical signal to boxes called optical nodes in local communities. At the nodes, the optical signals are transformed to RF signals and carried by various local CATV coax cables to different subscriber premises. As is known in the art, the subscriber premises may be a residence, commercial or industrial establishment. The digital data is typically modulated onto the RF carrier or channel using one of various formats and modulation schemes including Quadrature Amplitude Modulation (QAM), Quadrature Phase Shift Key (QPSK), etc.

DOCSIS systems are deployed typically on HFC networks supporting many CATV channels. In general, one CATV channel (e.g., in the 50-860 MHz range) is allocated to downstream data, and one or more other channels (e.g., in the 5-42 MHz range) is allocated to upstream data. The upstream and downstream bandwidth is shared with multiple users (e.g., active data subscribers). The DOCSIS system is essentially a point-to-multipoint communication system in the downstream direction, and a multipoint-to-point communication system in the upstream direction. DOCSIS systems typically utilize a continuous signal in the downstream direction and a time-division multiple-access (TDMA) burst signal in the upstream direction, which supports multiple symbol rates and formats (e.g., QPSK, xQAM). For example, in the downstream direction the CMTS transmits to a plurality of CM that share at least one downstream frequency, whereas in the upstream direction, the plurality of CMs generally contend for access to transmit at a certain time on an upstream frequency. With regard to the latter, today's DOCSIS CMs typically rely on a reservation scheme wherein the CMs request a time to transmit and the CMTSs grant time slots based on availability. This contention for upstream slots of time has the potential of causing collisions between the upstream transmissions of multiple cable modems. To resolve these and other problems resulting from multiple users sharing an upstream frequency channel to minimize costs for residential users, DOCSIS typically implements a media access control (MAC) algorithm.

In order to ensure DOCSIS systems operate reliably and at a high effective throughput, CATV installers typically perform a ranging measurement prior to each CM being initialized and registered by the network. In addition, CATV installers and/or technicians often perform a ranging measurement during diagnostic testing (e.g., when trouble-shooting). The ranging measurement measures the total amount of attenuation or gain between the test point (e.g., at or near the subscribers premises) and the CMTS.

CATV installers typically perform the ranging measurement using portable test instruments (e.g., for new installations, for measuring the performance of upstream channels, and/or for locating impairments within the system). In fact, after downstream levels and ingress scans, one of the most important measurements need by CATV installers is the DOCSIS ranging measurement, and in particular, the amount of attenuation between the test point at the subscriber's premises and the CMTS at the headend.

Traditionally, the test equipment for ranging measurements in DOCSIS systems is a portable device including a standard off-the-shelf DOCSIS chipset. For example, commercially available chipsets have been provided by Broadcom, NXP, and Intel. Unfortunately, recent generations of such chipsets are designed for extremely high bandwidth data transfer (e.g., up to 1.2 Gbps) and accordingly are complex, costly, specialized, power hungry, prone to obsolescence, and have long lead times. Incorporated into CATV test instruments, these limitations manifest as slow measurement times, costly high capacity batteries, elaborate thermal dissipation strategies, materials investment to ensure manufacturing capacity, and periodic hardware redesign to incorporate newly released components and avoid obsolescence issues.

### SUMMARY OF THE INVENTION

The instant disclosure relates to a method and test instrument for performing a ranging measurement in a DOCSIS network without a DOCSIS chipset. Instead of using a DOCSIS CM chipset, the ranging measurement is performed using low cost and general purpose electronics. For example, in one embodiment, these electronics include a downstream CATV receiver, including a CATV tuner and QAM demodulator, that accepts the downstream signals from the CMTS. The output of the demodulator is an MPEG transport stream containing DOCSIS signaling messages and data packets. Software algorithms running inside a suitable general purpose processor decode the MPEG transport stream. The processing entails MPEG and DOCSIS decoding, to isolate signaling messages from the data packets. The signaling messages are used to determine the appropriate format and timing of ranging request messages for the CMTS. The format of the ranging messages can be cached, as can the actual ranging waveforms. A burst generator is included for generating the RF return path messages to be sent to the CMTS.

According to one aspect of the present invention there is provided a method of ranging using a test instrument comprising the steps of: (a) extracting at least one message from a downstream channel of a Data Over Cable Service Interface Specification system, the at least one message including an upstream channel descriptor; (b) generating a ranging waveform in dependence upon the upstream channel descriptor, (c) triggering transmission of a ranging burst including the ranging waveform to a Cable Modem Termination System; (d) receiving a ranging response from the Cable Modem Termination System, the ranging response including a transmit level correction message determined in dependence upon analysis of the ranging burst, and (e) adjusting transmit levels in dependence upon the transmit level correction message; wherein steps (a) to (e) are performed other than with a Data Over Cable Service Interface Specification cable modem chipset.

According to another aspect of the present invention there is provided a test instrument for ranging comprising: a receiver for extracting at least one message from a downstream channel of a Data Over Cable Service Interface Specification system, the at least one message including an upstream channel descriptor; a processor for generating a ranging waveform in dependence upon the upstream channel descriptor, a burst generator for transmitting a ranging burst including the ranging waveform to a Cable Modem Termination System; wherein the receiver is for receiving a ranging response from the Cable Modem Termination System, the ranging response including a transmit level correction message determined in dependence upon analysis of the ranging burst, wherein the processor is for determining adjustments to transmit levels in dependence upon the transmit level correction message, and wherein the test instrument does not include a Data Over Cable Service Interface Specification cable modem chipset.

### BRIEF DESCRIPTION OF THE DRAWINGS

The invention will be described in greater detail with reference to the accompanying drawings, in which:

FIG. 1 is a schematic diagram of a DOCSIS system;

FIG. 2 is a block diagram of a test instrument for performing ranging measurements in the DOCSIS system illustrated in FIG. 1, in accordance with one embodiment of the instant invention;

FIG. 3 is a flow chart showing a ranging measurement using the test instrument illustrated in FIG. 2, in accordance with one embodiment of the instant invention; and

FIG. 4 is a block diagram of a test instrument for performing ranging measurements in the DOCSIS system illustrated in FIG. 1, in accordance with another embodiment of the instant invention.

It will be noted that throughout the appended drawings, like features are identified by like reference numerals.

### DETAILED DESCRIPTION

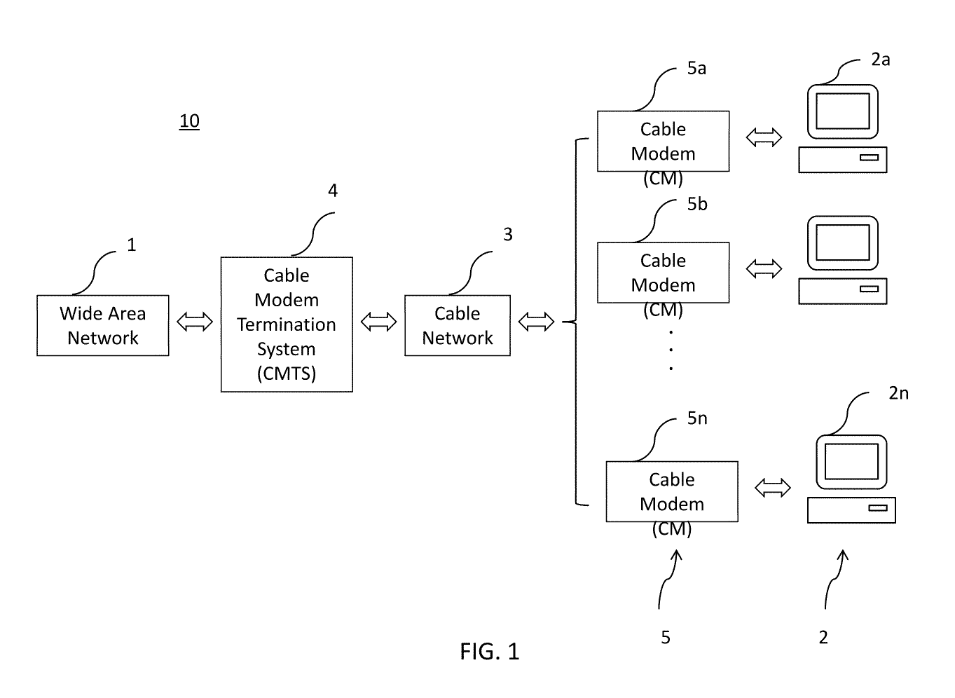

FIG. 1 shows the basic elements of one embodiment of a DOCSIS cable modem system. The DOCSIS system 10 includes a cable network 3, which typically comprises a hybrid fiber-coaxial (HFC) network, a cable modem termination system (CMTS) 4, and a plurality of multiple cable modems (CM) 5. The cable network 3 supports communication of data, such as Internet Protocol (IP) packets, between the plurality of CMs 5 and the CMTS 4. As will be appreciated by persons skilled in the relevant art, the CMTS 4 is located at the hub, or headend of the system, and operates, in part, as an interface between cable network 3 and a wide area network (WAN) 1. For example, the CMTS 4 may include a WAN connection, such as an Ethernet connection, that receives IP traffic. Each of the CMs 5a-5n operates as an interface between the cable network 3 and the corresponding customer premises equipment (CPE) 2. The term CPE refers to any type of electronic equipment located within the customers premises and connected to the network. For example, the CPE 2a-2n may include one or more devices, such as home routers, personal computers (PCs), televisions, set-top boxes, digital video recorders, portable devices, etc.

The CMs 5 are assigned to operate over various RF channels/carriers. For example, once the CMTS 4 receives registration information from the CM 5a, the CMTS 4 assigns the CM 5a to a specific upstream channel based on the receipt of the registration information, at which point the CM 5a may transmit data to the CMTS 4. The mechanism provided by the DOCSIS Specification for establishing an upstream channel is a MAC Management Message, termed an Upstream Channel Descriptor (UCD), which is broadcast by the CMTS 4 to all cable modems on the network. In order to allow more than one CM 5 use the same channel or carrier, the upstream channels are separated typically using multiplexing techniques (e.g., Advanced Time Division Multiple Access (ATDMA) or Frequency Division Multiple Access (FDMA). The DOCSIS upstream channels use a burst modulation format, which supports multiple symbol rates and formats (QPSK, xQAM). The modulation format includes pulse shaping for spectral efficiency, is carrier-frequency agile, and has selectable output power level. Each burst is variable in length and supports a flexible modulation, symbol rate, preamble, randomization of payload, and programmable forward error correction (FEC) encoding. All of the upstream transmission parameters associated with burst transmission outputs from the CMs 5 are configurable by the CMTS 4 via MAC messaging. Many of the parameters are programmable on a burst-by-burst basis. Data is transmitted via the RF channels by framing DOCSIS MAC frames into Motion Picture Experts Group—Transport Stream (MPEG-TS) packets.

The CMTS 4 is a computerized device that enables the CMs 5 to send and receive IP traffic over the cable network 3. The IP traffic is typically sent via the RF channels as IP packets over Layer 2 and may comprise, for example, Ethernet or SONET frames or ATM cell. For example, the IP packets are formed typically by framing DOCSIS MAC frames into Motion Picture Experts Group—Transport Stream (MPEG-TS) packets. In addition, the CMTS 4 typically controls the times at which CMs 5 are allowed to send upstream RF communications, as is well known in the art.

In order to maintain the operational integrity of the cable network 3, sophisticated test and analysis equipment is used typically to detect and resolve problems. While various test systems for monitoring cable networks during normal operation of the cable network have been proposed (e.g., U.S. Pat. No. 8,310,940 and U.S. Pat. No. 7,372,872), there remains a need for portable test instruments that CATV installers can use to obtain ranging measurements (e.g., as required for new CM installations, for measuring the performance of upstream channels, and/or for troubleshooting). For example, with regard to the latter, it is valuable for CATV installers to be able to move the test instrument for obtaining ranging measurements to various locations near/around the subscribers premises when locating impairments in the DOCSIS system. In addition, it is advantageous if the test instrument is a standalone device (i.e., does not require a second test instrument), thus simplifying the process.

In practice, it is common for portable test instruments for performing ranging measurements to be also used for other DOCSIS measurements (e.g., ping and trace route). Accordingly, these test instruments typically include a cable modem. More specifically, these test instruments typically include a DOCSIS cable modem chipset, and thus are relatively costly and periodically require upgrading. In accordance with one embodiment of the instant invention, a test instrument that does not include a DOCSIS cable modem chipset is used for providing ranging measurements (e.g., prior to a CM being installed).

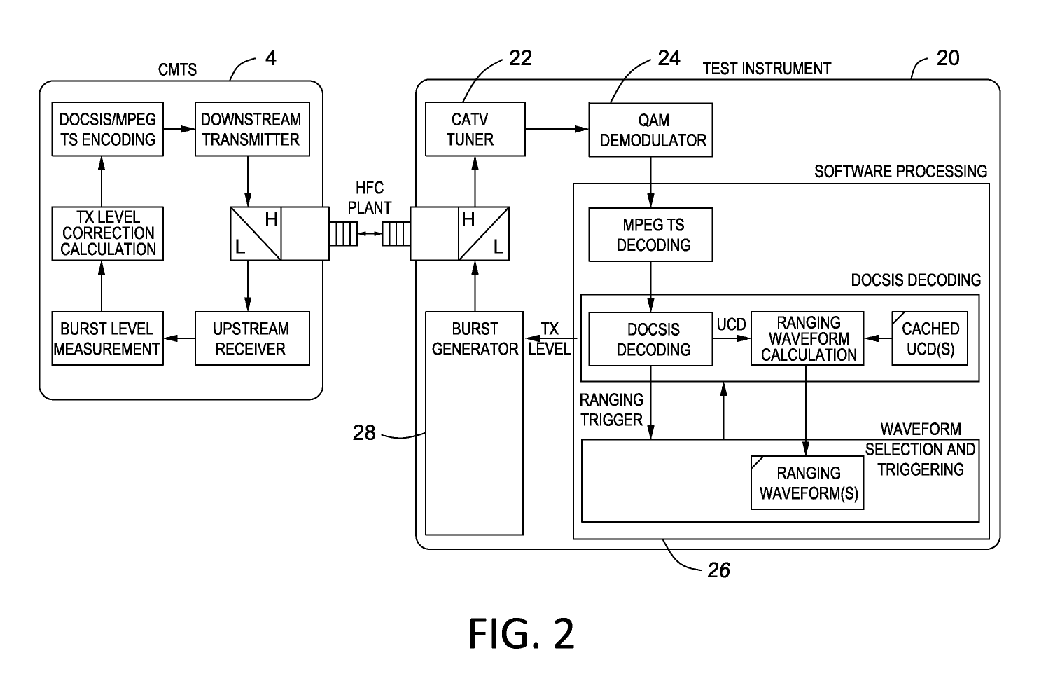

Referring to FIG. 2, there is shown a block diagram of a portable test instrument 20 for obtaining ranging measurements that does not use a DOCSIS chipset, in accordance with one embodiment of the instant invention. The portable test 20 instrument is intended to test or analyze performance aspects of the cable network 3 in a variety of locations, particularly those proximate one or more subscriber premises. For example, if a service provider receives notification of trouble in the cable network 3 through customer complaints (e.g. CM won't connect, slow internet connectivity, poor video quality, etc.), the service provider may send a CATV installer/technician, equipped with the portable test instrument 20, to diagnose the problem. The CATV installer/technician will perform ranging measurements at various locations in the network (e.g., near the subscriber premises).

Referring again to FIG. 2, the portable test instrument 20 includes a CATV tuner 22, a QAM demodulator 24, a controller including a processor 26, and a burst generator 28. The portable test instrument 20 is connected to the CMTS 4 via the cable network 3. Signals transmitted between the portable test instrument 20 and CMTS 4 are transmitted between the high/low filters labeled H/L.

The CATV tuner 22 receives the downstream radio frequency (RF) signals from the CMTS and converts the selected frequencies and associated bandwidth into a fixed frequency suitable for further processing (i.e., termed the Intermediate Frequency (IF)). The CATV tuner 22 typically will receive all television bands from 48 MHz to 1 GHz and will convert the selected channel to an industry standard IF between 4 and 60 MHz. For example, in one embodiment, the IF output of the CATV tuner 22 is centered at approximately 44 MHz and contains a single 6 MHz-wide TV channel to be demodulated. In another embodiment, the IF output of the CATV tuner 22 is centered at approximately 36 MHz and contains a single 8 MHz-wide TV channel to be demodulated. The CATV tuner is typically an analogue or digital tuner. One example of a suitable CATV tuner is a single-chip silicon tuner. Conveniently, CATV tuners suitable for the CATV tuner 22 are available as off-the-shelf components from various manufacturers. Some examples of suitable CATV tuners include MAX3543 from Maxim, BCM3422 from Broadcom, MT2131 from CSR, and the TDA182xx series from NXP.

The QAM demodulator 24 receives the IF signal from the CATV tuner 22 and digitizes it for further processing. In particular, the QAM modulator 24 demodulates the digital signal to generate a representation of the originally transmitted signal. Notably, QAM demodulation involves recovering information from both phase and frequency shifts in the modulated signal. Conveniently, QAM demodulators suitable for the QAM demodulator 24 are available as off-the-shelf components from various manufacturers. Some examples of a suitable QAM demodulator include the TDA1002x series from NXP.

Alternatively, the CATV tuner 22 and QAM demodulator 24 are combined on a single chip, which is available as an off-the-shelf component. For example, one example of a single-chip package suitable for use as the CATV 22 and QAM demodulator 24 is MxL261 by MaxLinear. Together, the CATV tuner 22 and QAM demodulator 24 accept the downstream signals from the CMTS 4 at the head end and produce a demodulated output. Notably, the output of the demodulator 24 is an MPEG transport stream containing DOCSIS signaling messages and data packets. In particular, the output signal of the demodulator is typically a parallel or serial data stream containing the MPEG transport stream packets. In embodiments wherein the output format is parallel, the data is sent on 8 lines with a clock and optionally a frame sync line providing timing to the MPEG receiver. In embodiments wherein the output is serial, the data is sent on one line with a second line providing the clock. The data rate of this interface is typically about 29-51 Mbps.

The processor 26 is a general purpose processor. Software algorithms stored in non-transitory memory and running inside the processor 26 decode the MPEG transport stream. The processing entails MPEG and DOCSIS decoding to isolate signaling messages from the data packets. The signaling messages are used to determine the appropriate format and timing of ranging request messages for the CMTS 4. More specifically, the signaling messages are used to determine the format of the ranging waveform to be transmitted to the CMTS 4. Optionally, the format of the messages and/or the actual ranging waveforms are cached.

The burst generator 28 generates the RF return path messages sent to the CMTS 4. More specifically, the burst generator 28 transmits the ranging waveform generated by the processor 26. The burst generator 28 typically includes Digital to Analog Conversion (DAC) and associated RF circuitry for transmitting the ranging waveform. The DAC typically will be operated at a sufficient sampling rate to allow direct conversion of bursts in the 5-85 MHz frequency range, such as 204.8 MSPS. Alternatively, the DAC is operated at a sampling rate nearer to the symbol rate of the upstream carriers, such as 20.48 MHz, and paired with RF modulator circuitry to upconvert the burst to the desired center frequency. In either case, the DAC output is typically amplified by an RF amplifier, attenuated in level by an adjustable RF attenuator, and filtered by a low pass “reconstruction” filter to reduce aliasing. Optionally, the burst generator is used to generate CW or QAM test signals for performing other tests and adjustments in the network, a capability known as Return Signal Generator (RSG).

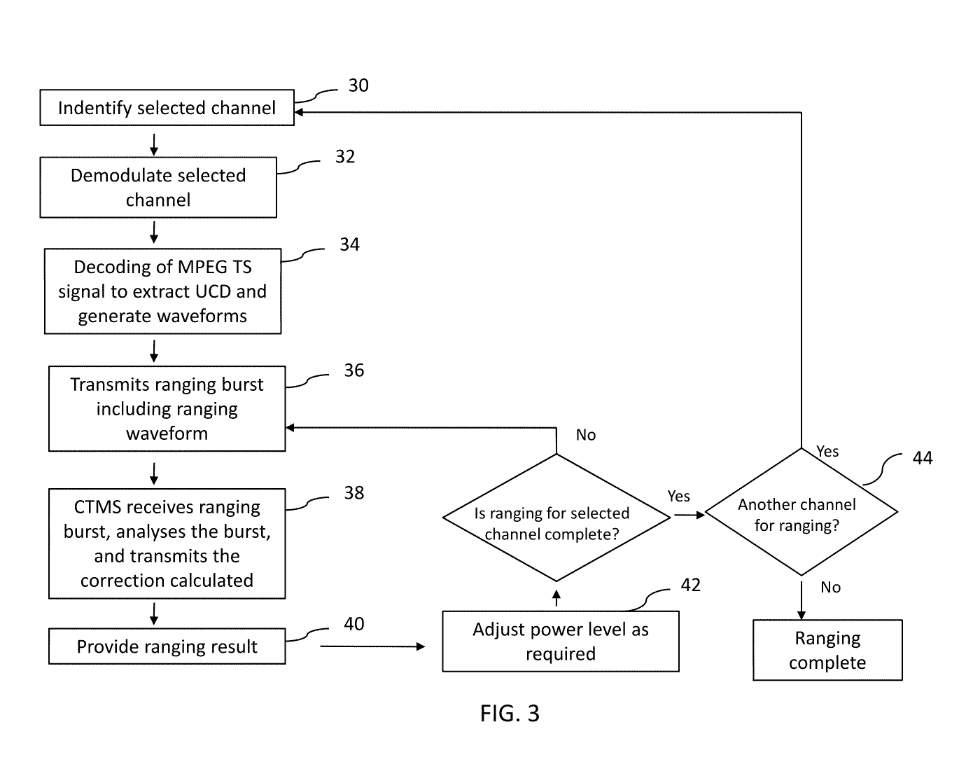

Referring to FIG. 2 and FIG. 3, ranging with the portable test instrument proceeds as follows:

At 30, the test instrument 20 is connected to the cable network 3, by for example a CATV installer and/or technician and the channel to be tested is identified. For example, in one embodiment the test instrument 20 is connected at the subscribers premises at a location where a CM is to be installed. In this embodiment, the channel to be tested is selected by the CATV installer/technician. In other embodiments, the channel to be tested is selected by a predetermined process.

At 32, the CATV tuner 22 and QAM demodulator 24 demodulate the user-specified downstream QAM channel and route the output Transport Stream (TS) to the general purpose processor 26.

At 34, the processor 26 performs MPEG TS and DOCSIS decoding, in accordance with the DOCSIS protocol specification, to extract various DOCSIS messages. For example, in one embodiment the DOCSIS messages of interest include the Upstream Channel Descriptor (UCD), the timing of the “initial ranging” opportunities or slots during which ranging bursts can be sent, and ranging burst response messages from the CMTS. The UCD is a type of MAC-layer management message which is sent downstream by the CMTS to all CMs, and contains information about the format of ranging bursts expected by the CMTS. In general, the UCD will include a Channel ID, mini-slot size, burst descriptors, etc. The processor 26 then determines a ranging waveform in accordance with the information in the UCD message. The ranging waveform is generated in real-time, or is pre-generated and stored in memory. If the same UCD has been previously encountered, and cached ranging waveforms are available, the waveform is generated from the stored waveforms and is not recomputed.

At 36, the DOCSIS decoder identifies initial ranging opportunities, which are used to trigger the transmission of the ranging waveform via the DAC and associated RF circuitry of the burst modulator 28. More specifically, the initial ranging opportunities are identified by determining timing offsets the test instrument must apply to its transmission. The transmit level of the first ranging message is set typically to a conservative (low) power level to prevent overloading the CMTS receiver or return path components.

At 38, the CMTS 4 receives the burst at the upstream receiver, measures its power level, computes a transmit level correction, and, via its DOCSIS/TS encoder and downstream transmitter, sends this transmit level correction to the test instrument 20.

In accordance with the DOCSIS specification, the CMTS 4 will typically determine the correction by specifying the relative change in transmission power level that the device is to make in order that transmissions arrive at the CMTS 4 at the desired power. For example, in one embodiment the correction is simply the target power level minus the measured power level of the last ranging burst from the test instrument 20. In other embodiments, the CMTS 4 uses a proprietary algorithm to determine the correction (e.g., as selected by the CMTS vendor). The ranging result, including the correction, is transmitted to the test instrument 20.

At 40, transmit level correction messages are extracted by the DOCSIS decoder in the processor 26 and the transmit level plus the correction value is presented to the user as the ranging result using a display of the test instrument 20.

At 42, the transmit levels of the test instrument are adjusted, as required. This is repeated until the CMTS 4 declares ranging to be complete. The transmit power is adjusted according to the CMTS' instruction, as described above. For example the CMTS 4 might instruct the test device 20 to reduce the power of the burst signal by 3 dB, and then the transmitter would do so.

In general, the CMTS/test device power adjustment process is an iterative process and rarely succeeds on the first try. For example, the initial ranging burst might be measured by the CTMS 4 as 12.4 dB too weak. The CMTS 4 would tell the test device 20 to increase power by 12 dB. After doing so, another ranging packet is transmitted by the test device 20, and the CMTS finds it is 0.8 dB too strong (due to some imperfections in the measuring or adjustment algorithms or circuits). The CMTS 4 then instructs the test device to reduce power by 1 dB. When done, the CMTS 4 then finds the level is 0.3 dB too low, however, the CMTS then declares “close enough”, e.g. within 0.5 dB, and aka “ranging complete”. Ranging completion is signaled to the test device 20 as a ranging response message with the status set to “success” (e.g., instead of “continue”). Alternatively, if the test device 20 reaches its minimum or maximum transmit level and cannot achieve the output signal level commanded by the CMTS 4, or if a predefined maximum number of attempts is reached, ranging is declared by the test device 20 to have failed. In this case, the user is notified that an Over-range or Under-range error has occurred.

At 44, if ranging measurements are required for other channels, the channel is switched and the process repeated beginning at 30. In one embodiment, the channel is incremented for each iteration and the process is repeated until ranging on all DOCSIS upstream channels is complete. In another embodiment, ranging is performed simultaneously on all DOCSIS upstream channels.

Notably, the method illustrated in FIG. 3 exploits the fact that within the DOCSIS protocol, ranging is performed prior to any type of authentication or registration. Any device that transmits valid ranging bursts at valid ranging times will be sent acknowledgement from the CMTS 4, including transmit power adjustment requests. Accordingly, a second test instrument located at or near the headend is not required.

Advantageously, since the test instrument 20 does not require a DOCSIS cable modem chipset, but instead makes use of low cost and general purpose electronics to perform the ranging measurement, it is relatively inexpensive and is relatively immune from obsolescence issues.

Further advantageously, since the tuner 22 and demodulator 24 are formed on separate chips, or the same chip, but are not integrated into a DOCSIS chipset, the interfaces between the tuner and the demodulator and/or between the demodulator and the MPEG transport decoder are accessible, and thus useful. In particular, these interfaces allow the test equipment to provide direct external access to the IF signal, which is not possible with an integrated cable modem chipset. Direct access to the IF signal allows the IF signal to be digitized and analyzed to detect a variety of other measurement parameters, including power level, signal stability (Hum, AGC stress), narrowband interference, guard band noise, analog channel measurements, etc. In addition, these interfaces allow the test equipment to provide direct external access to the MPEG TS, which is generally not possible with an integrated cable modem chipset. Direct access to the MPEG TS allows the MPEG stream to be analyzed to perform other useful measurements such as percent utilization, MPEG quality testing (e.g., TR 101 290), and/or MPEG decoding to render video streams being delivered.

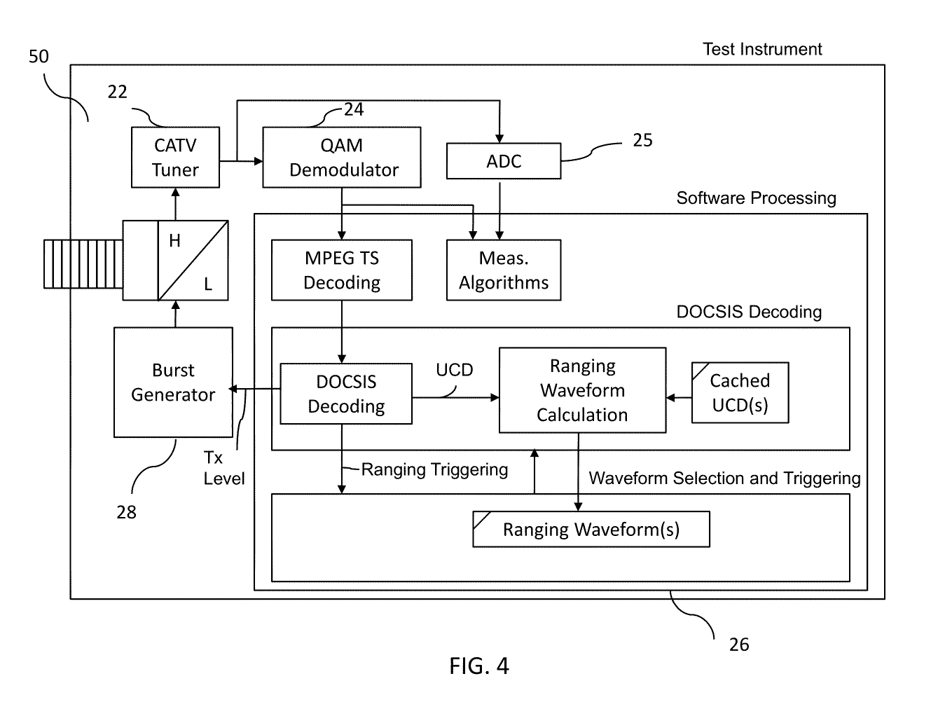

Referring to FIG. 4, there is shown an embodiment of a test instrument in accordance with another embodiment of the instant invention. The test instrument 50 includes the CATV tuner 22, the QAM demodulator 24, the controller including a processor 26, the burst generator 28, and an Analogue to Digital Converter (ADC) 25.

In this embodiment, the CATV tuner 22 and QAM demodulator 24 are formed on separate chips and mounted on a same circuit board. The IF output of the CATV tuner 22 is passed through the ADC 25, where it is digitized and subsequently analyzed using software algorithms stored in memory to determine power level, signal stability, narrowband interference, and/or guard band noise. The MPEG TS output of the QAM demodulator 24 is analyzed using software algorithms stored in memory to determine percent utilization and/or MPEG quality testing.

Accordingly, it is clear that using the CATV tuner 22 and QAM demodulator 24, which are obtained as separate off-the-shelf components, advantageously allows additional parameters to be measured. In addition, using separate off-the-shelf components allows the processor, to run computer executable code stored on non-transitory memory to analyze the outputs from the tuner and the Quadrature Amplitude Modulation demodulator directly (e.g., without decoding).

Table 1 further illustrates the advantages and disadvantages of a test instrument utilizing low cost and general purpose electronic components rather than a DOCSIS chipset to perform the ranging measurement. In particular, Table 1 compares the strengths and weakness of a conventional DOCSIS chipset-based test instrument and a portable test instrument in accordance with one embodiment of the instant invention.

TABLE 1
Relative strengths and weaknesses of test equipment for performing
ranging measurements with and without a DOCSIS chipset.

| | DOCSIS chipset-based | Test instrument without |
|---|---|---|
| Criteria | test instrument | a DOCSIS chip-set |
| Natively | Yes, including registration, | No, supports only ranging |
| supports | RSG*, throughput*, packet | and RSG. IP layer tests |
| advanced | loss*, VoIP check*, ping, | need to be performed via |
| DOCSIS | traceroute | customer's cable modem. |
| measurements | *with software | |
| | customization | |
| Measurement | Moderate | Low |
| hardware cost | | |
| DOCSIS | 6-12 months | N/A |
| chipset | | |
| release cycle | | |
| DOCSIS | ~5 years | N/A |
| chipset | | |
| life cycle | | |
| Battery | 10 W-hours | <1 W-hour |
| capacity | | |
| for 100 | | |
| ranging | | |
| measurements | | |
| Time to | 30-60 seconds | 5-10 seconds for cached |
| measurement | | UCD scenario |
| result | | |
| Sole-sourced | DOCSIS chipset, LNA | Tuner and demodulator |
| components | | |

Referring to Table 1, although each of the test instruments 20,50 supports fewer measurements (e.g., supports ranging and Return Signal Generator (RSG) measurements, but not IP layer tests), it is clear that the relatively low cost, increased battery life, and fast measurement times of these portable test devices make them viable alternatives to traditional DOCSIS chipset-based portable test instruments used to perform ranging measurements.

With regard to the measurement times, the decreased measurement times are at least partially related to the use of cached UCDs/waveforms to generate the ranging waveforms. Accordingly, the test instrument 20 is particularly advantageous for DOCSIS systems, which as known in the art, typically use UCD messages to describe a particular channel, and thus do not typically change. For example, since the UCD messages are periodically sent to provide information about a channel to new CMs attempting to join the network, the UCD messages for a particular channel typically will remain the same, once established. More specifically, the parameters of a particular channel (as described by a UCD message with a particular Channel ID), including those used to generate the ranging waveform, do not change.

Of course, the above embodiments and applications have been provided as examples only. It will be appreciated by those of ordinary skill in the art that various modifications, alternate configurations, and/or equivalents will be employed without departing from the spirit and scope of the invention. Accordingly, the scope of the invention is therefore intended to be limited solely by the scope of the appended claims.

What is claimed is:

1. A method of ranging using a test instrument comprising the steps of:
(a) extracting at least one message from a downstream channel of a Data Over Cable Service Interface Specification system, the at least one message including an upstream channel descriptor;
(b) generating a ranging waveform in dependence upon the upstream channel descriptor,
(c) triggering transmission of a ranging burst including the ranging waveform to a Cable Modem Termination System;
(d) receiving a ranging response from the Cable Modem Termination System, the ranging response including a transmit level correction message determined in dependence upon analysis of the ranging burst, and
(e) adjusting transmit levels in dependence upon the transmit level correction message;
wherein steps (a) to (e) are performed other than with a Data Over Cable Service Interface Specification cable modem chipset.

2. The method of ranging according to claim 1, wherein the step of generating the ranging waveform comprises searching for at least one of cached upstream channel descriptors and cached ranging waveforms, each of the cached upstream channel descriptors and each of the cached ranging waveforms stored in non-transitory memory and associated with a different channel on the Data Over Cable Service Interface Specification system.

3. The method of ranging according to claim 1, wherein the step of extracting the at least one message comprises demodulating the downstream channel with a tuner and a Quadrature Amplitude Modulation demodulator and decoding an output of the Quadrature Amplitude Modulation demodulator using a processor in the test instrument, the decoding including Motion Picture Experts Group Transport Stream decoding and Data Over Cable Service Interface Specification decoding.

4. The method of ranging according to claim 3, wherein at least one message includes timing and available slots for initial ranging messages, and wherein the step of triggering transmission of the ranging burst comprises transmitting the ranging burst according to the timing.

5. The method of ranging according to claim 4, wherein the step of generating a ranging waveform comprises generating the ranging waveform in real-time.

6. The method of ranging according to claim 4, wherein the step of generating a ranging waveform comprises generating the ranging waveform from a cached waveform.

7. The method of ranging according to claim 4, wherein the step of generating a ranging waveform is performed by the processor using code stored in the non-transitory memory.

8. The method of ranging according to claim 3, comprising the step of digitizing an Intermediate Frequency output of the tuner with an Analogue-to-Digital Converter and analyzing the digitized output using the processor, wherein the digitized output is other than demodulated.

9. A test instrument for ranging comprising:
a receiver for extracting at least one message from a downstream channel of a Data Over Cable Service Interface Specification system, the at least one message including an upstream channel descriptor;
a processor for generating a ranging waveform in dependence upon the upstream channel descriptor,
a burst generator for transmitting a ranging burst including the ranging waveform to a Cable Modem Termination System;
wherein the receiver is for receiving a ranging response from the Cable Modem Termination System, the ranging response including a transmit level correction message determined in dependence upon analysis of the ranging burst,
wherein the processor is for determining adjustments to transmit levels in dependence upon the transmit level correction message, and
wherein the test instrument does not include a Data Over Cable Service Interface Specification cable modem chipset.

10. A test instrument according to claim 9, wherein the processor is for searching for at least one of cached upstream channel descriptors and cached ranging waveforms, each of the cached upstream channel descriptors and each of the cached ranging waveforms stored in non-transitory memory of the test instrument, and associated with a different channel on the Data Over Cable Service Interface Specification system.

11. A test instrument according to claim 10, wherein the receiver includes a tuner and a Quadrature Amplitude Modulation demodulator.

12. The test instrument according to claim 11, wherein the tuner and the Quadrature Amplitude Modulation demodulator are formed on different chips.

13. The test instrument according to claim 11, wherein the tuner and the Quadrature Amplitude Modulation demodulator are formed on a same chip.

14. The test instrument according to claim 11, wherein the tuner and the Quadrature Amplitude Modulation demodulator are separate off-the-shelf components.

15. The test instrument according to claim 14, including an Analogue-to-Digital Converter for digitizing an Intermediate Frequency output of the tuner.

16. The test instrument according to claim 11, wherein the processor is a general purpose processor.

17. The test instrument according to claim 16, wherein the non-transitory memory includes computer executable code stored thereon, the computer executable code for performing Motion Picture Experts Group Transport Stream decoding and Data Over Cable Service Interface Specification decoding to extract the upstream channel descriptor.

18. The test instrument according to claim 15, wherein the non-transitory memory includes computer executable code stored thereon, the computer executable code for analyzing an output of the Analogue-to-Digital-Converter.

19. The test instrument according to claim 11, comprising a display for displaying a ranging result, the ranging result determined in dependence upon the ranging response.

20. The test instrument according to claim 11, wherein the test instrument is a portable device.
